(19) United States
(12) Patent Application Publication
(10) Pub. No.: US 2026/0080698 A1
(43) Pub. Date: Mar. 19, 2026

(54) METHOD FOR THE SEMANTIC SEGMENTATION OF A POINT CLOUD

(71) Applicant: Robert Bosch GmbH, Stuttgart (DE)

(72) Inventors: Johannes Reinhardt, Renningen (DE); Daniel Niederloehner, Stuttgart (DE); Holger Wunsch, Tuebingen (DE); Julia Rebecca Lust, Stuttgart (DE); Patrick Ziegler, Waiblingen (DE)

(21) Appl. No.: 19/299,435

(22) Filed: Aug. 14, 2025

(30) Foreign Application Priority Data
Sep. 18, 2024 (DE) 10 2024 208 927.3

(51) Int. Cl. G06V 20/70; G06V 10/82

(52) U.S. Cl. CPC G06V 20/70; G06V 10/82

(57) ABSTRACT

A method for the semantic segmentation of a point cloud by a neural network in a driver assistance system for motor vehicles, in which a neighborhood is defined for each individual point of the point cloud, the neighborhood being a set of other points of the point cloud located in the vicinity of the point, and in which a feature of an individual point is convolved with features of the points in its neighborhood according to a learned weight matrix. The points of the point cloud are ordered to form a sequence by assigning each point an ordinal number which indicates its position in the sequence. An algorithm is used to create the sequence. The algorithm ensures that the difference between the ordinal numbers of any two points correlates positively with the spatial distance of these points in the point cloud.

### CROSS REFERENCE

The present application claims the benefit under 35 U.S.C. § 119 of Germany Patent Application No. DE 10 2024 208 927.3 filed on Sep. 18, 2024, which is expressly incorporated herein by reference in its entirety.

### FIELD

The present invention relates to a method for the semantic segmentation of a point cloud by a neural network in a driver assistance system for motor vehicles, in which a neighborhood is defined for each individual point of the point cloud, the neighborhood being a set of other points of the point cloud located in the vicinity of the point, and in which a feature of the individual point is convolved with features of the points in its neighborhood according to a learned weight matrix.

### BACKGROUND INFORMATION

In driver assistance systems for motor vehicles, a model of the vehicle's environment is generated on the basis of on-board sensors, which usually include radar and/or lidar sensors. This model then forms the basis for decisions about actions of the driver assistance system. The positioning data of a sensor, for example a radar sensor, can be represented as two- or three-dimensional point clouds, in which each received radar reflection is represented by a point whose coordinates in a Cartesian coordinate system (or in polar coordinates) indicate the position of the corresponding radar target in space. If the radar sensor is angle-resolving in both azimuth and elevation, a three-dimensional point cloud is obtained with the coordinates distance, azimuth angle and elevation angle, which can be converted into Cartesian coordinates x, y, z. In addition, each point is assigned one or more features that further characterize the point. In the case of a radar sensor, these characteristics can be, for example, the radial velocity of the radar target (possibly corrected for the vehicle's own motion) or the radar scattering cross section. In addition to such local features, non-local features can also be assigned to the point, which characterize certain relationships between this point and other points in the cloud.

In a generalized sense, the coordinates of the points can also be regarded as “features.” For example, in a three-dimensional point cloud, each point has a feature set, the first three features of which are the three spatial coordinates, followed by further features such as radial velocity, scattering cross section, and the like. The term “feature” is to be understood in this generalized sense.

“Semantic segmentation” is intended here to generally designate the process by which a model of the vehicle environment is generated from the point cloud. In the simplest case, semantic segmentation can involve the location and classification of a single object (e.g. as a vehicle or traffic sign). For multi-part objects, semantic segmentation can also include identifying the individual parts and the relationships of these parts to one another. At the most complex level, semantic segmentation provides a more or less detailed description of the entire traffic environment, including the objects present therein.

In order to be able to use a neural network for semantic segmentation, a representation of the point cloud is often chosen that allows some kind of convolution operation. Such convolution operations make it possible to recognize certain structures in the locations and features of a limited number of points that are adjacent to each other. Since these structures are independent of the location in space of this group of neighboring points, a certain translation invariance is achieved. This means that if the network has learned, for example, to recognize and correctly classify an object at the left edge of the visual field, it requires only very little additional learning effort to recognize the same object at the right edge of the visual field.

In Lang et al.: “PointPillars: Fast Encoders for Object Detection from Point Clouds” (openaccess.thecvf.com/content_CVPR_2019/papers/Lang_PointPillars_Fast_Encoders_for_Object_Detection From_Point_Clouds_CVPR_2019_paper.pdf) a grid-based method is described that allows convolution operations on a two-dimensional point cloud. A regular two-dimensional grid is placed over the entire field of view, and a convolutional neural network (CNN) is used to recognize structures in the point cloud in a similar way to digital image recognition.

Swanningson et al., in: “Radar Point GNN: Graph Based Object Recognition for Unstructured Radar Point-cloud Data” (ieeexplore.ieee.org/document/9455172), describe a neural network that performs convolution operations on a graph representing neighborhood relationships between the points in the point cloud.

The conventional convolutional networks differ in terms of computational effort and memory requirements. In grid-based approaches, the computational effort and memory requirements scale quadratically (for a 2D point cloud) or cubically (for a 3D point cloud) with the number of grid cells, regardless of the number of points in the point cloud. For point clouds with a comparable low density, such as those obtained from radar sensors in particular, these methods therefore have only a low efficiency.

In graph-based approaches, the computational and storage effort only scales with the number of points in the point cloud, so that higher efficiency is achieved in many applications. However, generating a graph that meaningfully represents the point cloud requires relatively complex algorithms.

### SUMMARY

An object of the present invention is to provide a method for semantic segmentation which is characterized by low memory and computational outlay and can be efficiently executed with limited hardware resources.

This object may be achieved according to the present invention in that the points of the point cloud are ordered to form a sequence by assigning each point an ordinal number which indicates its position in the sequence, an algorithm being used to create the sequence, which algorithm ensures that the difference between the ordinal numbers of any two points correlates positively with the spatial distance between these points in the point cloud, and that the neighborhood of an individual point is defined as a set of points of which the ordinal numbers form a series of consecutive numbers containing the ordinal number of the individual point.

Since this method rearranges the point cloud into a one-dimensional sequence, the subsequent convolution operation is reduced to a one-dimensional convolution, i.e., an operation analogous to a point-wise convolution on a discrete one-dimensional grid. The memory and computational outlay for the convolution operation therefore only scales with the comparatively limited number of points in the (one-dimensional) neighborhood, both during training of the network and during the actual semantic segmentation. This makes it easier to perform this operation using the embedded hardware of a motor vehicle's driver assistance system. In addition, the extensive literature on one-dimensional convolution and the experience gained in this field can be consulted.

Advantageous embodiments of the present invention are disclosed herein.

Unlike other well-known point-based architectures (e.g., Qi et al.: “PointNet: Deep Learning on Point Sets for 3D Classification and Segmentation”—openacess.thecvf.com/content_cvpr_2017/papers/Qi_PointNet_Deep_Learning_CVPR_2017_paper.pdf—), the method according to the present invention disclosed herein is not invariant under permutations of the point sequence. On the contrary, the order in which the points are arranged to form the sequence plays a central role in the approximate representation of the spatial relationships of the points in the 2D or 3D point cloud. It is important that the distance between two points in the sequence correlates positively with the spatial distance between these points in the cloud. In other words, if two points are close to each other in the sequence, they will usually also be relatively close to each other in the cloud. This property of the sequence can be achieved with a variety of conventional algorithms, for example in the case of a two-dimensional point cloud by ordering the points according to increasing x-coordinate and—if the x-coordinate is the same—according to increasing y-coordinate, or vice versa. Another possibility is to fill the field of view of the sensors with a space-filling path, i.e. a continuous path that approaches every point in the plane or space up to a distance that is smaller than a specified limit. Each point in the point cloud is then assigned to the position on the path closest to that point, and the order of these positions on the path determines the order of the points in the sequence. Another possible algorithm is the Cuthill-McKee algorithm (en.wikipedia.org/wiki/Cuthill%E2%80%93McKee_algorithm). All these conventional algorithms can be generalized to three dimensions in an obvious way.

Unlike grid-based convolution algorithms, the method of the present invention disclosed herein is also not intrinsically translation-invariant. However, translation invariance can be achieved at least approximately by restricting the space of admissible weight matrices in an appropriate way. Furthermore, it is possible to mask the weight matrix so that the weights for point pairs that are too far apart are forced to 0.

Numerous variants of methods for the actual discrete convolution operation are described in the literature (see, for example, Chollet: “Xception: Deep Learning with Depth Side Separable Convolutions”—arxiv.org/pdf/1610.02357.pdf—). These variations are also possible in the method proposed here.

In the following, exemplary embodiments of the present invention are explained in more detail with reference to the figures.

### BRIEF DESCRIPTION OF THE DRAWINGS

FIG. 1 is a block diagram of main parts of a driver assistance system which is configured for the method according to an example embodiment of the present invention.

FIG. 2 is a sketch for the explanation of some basic principles of discrete convolution methods.

FIG. 3 shows a simplified example of a two-dimensional point cloud whose points are ordered in a sequence.

FIG. 4 is a diagram showing the true distances between successive points in the sequence of FIG. 3.

FIG. 5 shows the same point cloud as FIG. 3, but sequenced using an area-filling path.

FIG. 6 is a diagram showing the true distances between successive points in the sequence of FIG. 5.

FIG. 7 is a diagram showing the true distances between the first point of the sequence and every other point of the sequence in FIG. 5.

FIG. 8 shows a more realistic example of a point cloud as it might be provided by a radar system of a motor vehicle.

FIG. 9 shows the point cloud according to FIG. 8 together with a space-filling path for sequencing this point cloud.

FIG. 10 shows the result of sequencing the point cloud in FIG. 9.

FIG. 11 shows an example of three extended features of the points of the point cloud as functions of the position of the points in the sequence.

FIG. 12 shows a neighborhood graph of the point cloud sequenced according to FIG. 10.

FIG. 13 shows a comparative example of a neighborhood graph created according to a different criterion.

FIGS. 14-17 are flow diagrams for the explanation of different example variants of the method according to the present invention.

### DETAILED DESCRIPTION OF EXAMPLE EMBODIMENTS

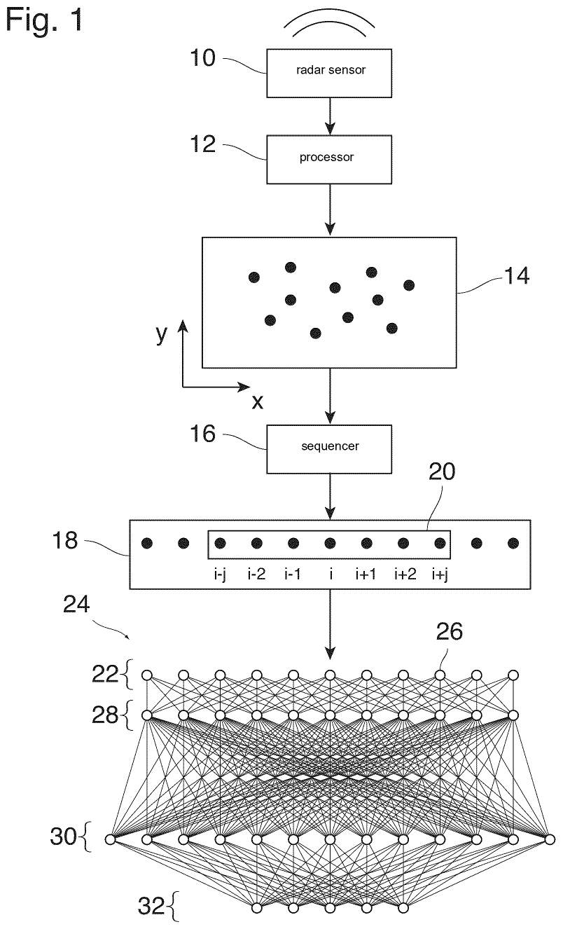

FIG. 1 shows a simplified block diagram of those parts of a driver assistance system that are used to create an environment model. A radar sensor 10 measures the distances, azimuth angles and relative speeds of objects located within a certain field of view of the radar sensor. A processor 12 converts the distances and azimuth angles into Cartesian coordinates (x, y) and creates a two-dimensional point cloud 14 in which each point represents the location of a detected radar target. A sequencer 16 arranges the points of the point cloud into a sequence 18 by assigning an ordinal number i (i=1, . . . , N) to each of the N points of the point cloud. For this purpose, the sequencer 16 uses an algorithm, described in more detail later, which ensures that the true distance between any two points in the point cloud 14 correlates positively with the difference between the ordinal numbers of these points. In other words, the sequence 18 is formed in such a way that two points that are close to each other in the point cloud 14 will usually also be close to each other in the sequence 18.

In the sequence 18, a neighborhood 20 is then defined for each point with the ordinal number i, which consists of the j+1 points with the ordinal numbers ij, . . . , i−1, i, i+1, . . . , i+j (in the example shown, j=3).

In the (highly simplified) example shown here, each point in sequence 18 has three generalized features, namely its coordinates x, y and (as a “true” feature) its radial velocity calculated on the basis of the Doppler shift. These generalized features of the points in the sequence 18 form the input data for a first layer 22 of a convolutional neural network 24 (CNN). The first layer 22 has a number of units 26 (also called nodes or neurons), and there is a 1:1 relationship between the points in the sequence 18 and the units 26. This assumes that the number N of points in the point cloud is equal to the number of units in the layer 22. This requirement does not always have to be met in practice. In general, the network 24 will be designed so that the number of units in the first layer is greater than the maximum expected number of points in a point cloud. If the number of points in the point cloud is smaller, the point cloud is filled with virtual points for whose features any suitable values are assumed (a procedure called “padding”). To ensure that this padding does not cause too much damage during further processing of the data, the information about whether each point is a virtual point or a real point is stored as an additional feature.

A second layer 28 of the neural network 24 has the same number of units as the first layer 22, and the units of the second layer are also assigned 1:1 to the ordinal numbers i of the points in the sequence 18. Each unit in the second layer 28 is linked by non-zero weights (symbolized by lines) to the units 26 in the first layer that lie within the neighborhood 20, i.e. to the units of the first layer whose ordinal number differs by at most 3 from the ordinal number of the unit in layer 28.

To simplify the illustration, it will be assumed for the time being that the points in the sequence 18 each have only a single feature. The values of these features are then entered into the corresponding units 26 of the first layer 22. A convolution operation now consists in forming in each unit of the second layer 28 a weighted sum of the values of the units of the first layer 22 that lie in the environment 20, wherein the weights that indicate the strength of the connection between the units of the first and second layers are determined by a weight matrix. In the second layer 28, in this way for each position in the sequence 18 a value is calculated which depends on the values of the features of the neighbors in the neighborhood 20 in a manner given by the weight matrix. In most cases, to the values calculated in this way a so-called bias is added which is independent of the values of the units in the first layer 22.

However, since each point in the sequence 18 is assigned four features (the coordinates x, y, the radial velocity and the feature that identifies virtual points), four data channels must be provided for each unit 26 shown in FIG. 1 in the first layer. In other words, instead of a single unit 26 (with only one channel), there are four such units, all assigned to the same position in the sequence 18. Figuratively speaking, the units 26 of the first layer then form four layers that are stacked one above the other in the direction perpendicular to the plane of the drawing in FIG. 1.

The second layer 28 can also have a plurality of layers, each representing a new feature. In general, the number and importance of the features in the second layer can be different from the number and importance of the features in the first layer, and a unit for a feature in the second layer 28 can also be linked by the weight matrix to units in the first layer 22 that are located in different positions. In principle, it is possible to combine the original features of the points in the second layer into a smaller number of features or, conversely, to generate a larger number of “artificial” features from the original features.

A mostly non-linear activation function is then applied to the weighted sums calculated in the units of the second layer 28 before the results are passed to another layer 30. In the example shown, this additional layer 30 is a fully interconnected layer, i.e. no further convolution operation takes place; rather, each unit in layer 30 is linked to each unit in layer 28. The number of units in layer 30 may be different from the number of units in the first layer 22, and the units in layer 30 do not need to be assigned to specific positions in sequence 18.

In the third layer 30, a weighted sum of the activation function values calculated in layer 28 is also calculated using a weight matrix. These weighted sums calculated in layer 30 are then passed on to the next layer 32 (usually without applying a nonlinear activation function). In the example shown, this layer 32 is again a fully networked layer, which also represents the output layer of the neural network 24. The values calculated here together form a description of properties of the point cloud 14, from which it is possible for example to derive which objects are located at which locations in the field of view of the radar sensor 10.

In practice, the number of layers and the number of units per layer of the neural network will be significantly larger than in the example shown here. In particular, a plurality of convolution layers stacked on top of one another can be provided, the units of which are assigned to the positions of the points in the sequence 18 in a similar way to the units of layer 28 and which perform the convolution operations on the results of the preceding convolution layer.

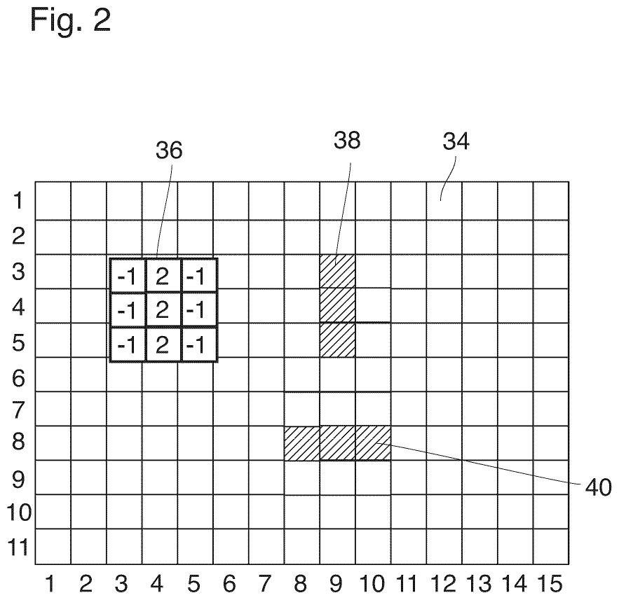

To illustrate the general functioning of convolutional neural networks (CNNs), a simple example of a conventional grid-based CNN is considered in FIG. 2. The input layer receives brightness values from “pixels” or square grid cells 34 arranged in a rectangular grid with 11 rows and 15 columns. For the cell in the fourth column and fourth row, a neighborhood 36 is shown, which consists of this cell itself and its eight immediate neighbors.

A so-called kernel is defined on the neighborhood, which assigns a weight to each point in this neighborhood. In the example shown, all points in the middle column of the kernel have a weight of 2, and all other kernel cells have a weight of −1. In a convolution operation for the grid cell with column and row indices (4,4), the weighted sum of the brightness values of the cells in the neighborhood 36 is formed with the weights specified by the kernel. The same convolution operation is also performed for the neighborhoods of all other grid cells. Graphically speaking, the equivalent is to move the kernel step by step across the grid in the horizontal and vertical directions until the kernel has covered the entire grid. The step size can correspond to the width of a single grid cell or, for example, twice this width.

In the example shown, the brightness pattern of the grid cells forms a vertical line element 38 and a horizontal line element 40. If the kernel is shifted to the right from the position shown in FIG. 2 with a step size of 1, after five steps a position is reached in which the three dark grid cells of the line element 38 have a weight of 2. The weighted sum for the middle ones of these cells then has the maximum value 6. For the top and bottom cells of line element 38, the weighted sum would each have the value 4.

If you move the kernel further down, it eventually reaches a position where the cells of the horizontal line element 40 have the weights −1, 2 and −1. The weighted sum for the grid cells (9,7), (9,8) and (9,9) is then 0, the same as in a completely white neighborhood. The kernel shown here is thus set up to detect vertical line segments such as the segment 38, but is blind to horizontal line segments.

The weight matrix that links the input layer of the CNN with the first convolutional layer represents the totality of all kernel positions on the grid and thus (at least with a step size of 1) causes the convolution operations for all neighborhoods of all grid cells. However, the weight matrix could be thinned out by choosing a step size of 2 in the vertical direction. The vertical line segment 38 would then still be easy to find.

There is a certain complication with the grid cells that lie at the edge of the grid, because then part of the kernel is located outside the grid. However, this can be remedied by padding, which adds virtual grid cells with a brightness value of 0.

The weighted sums obtained in the second layer of the network have a high value for precisely those units that correspond to the positions of vertical line segments. The values passed from the second layer to a next-higher layer therefore form a kind of map that indicates the positions of all vertical line segments. Accordingly, a second kernel (rotated by) 90° could be used to selectively search for horizontal line segments such as segment 40.

Once the CNN has learned the correct weights for a kernel, the sought structures can be found wherever they are on the grid. In this sense, the grid-based CNN is translation-invariant, i.e. insensitive to spatial displacements of the line segments 38, 40.

The dark-colored grid cells in FIG. 2 could also represent points of a point cloud. Accordingly, the CNN shown in FIG. 2 could also be used analogously for the segmentation of point clouds. However, the number of required calculation operations and the required storage space would then be determined solely by the resolution of the grid and independent of the number of points in the point cloud, so that only low efficiency would result for sparse point clouds.

To reduce the computational effort, a method is proposed in which the convolution operation is not grid-based but point-based and the kernel has, not two or three dimensions, but only a single dimension. To do this, the points of the point cloud are arranged in a one-dimensional sequence, within which a neighborhood is then defined for each point.

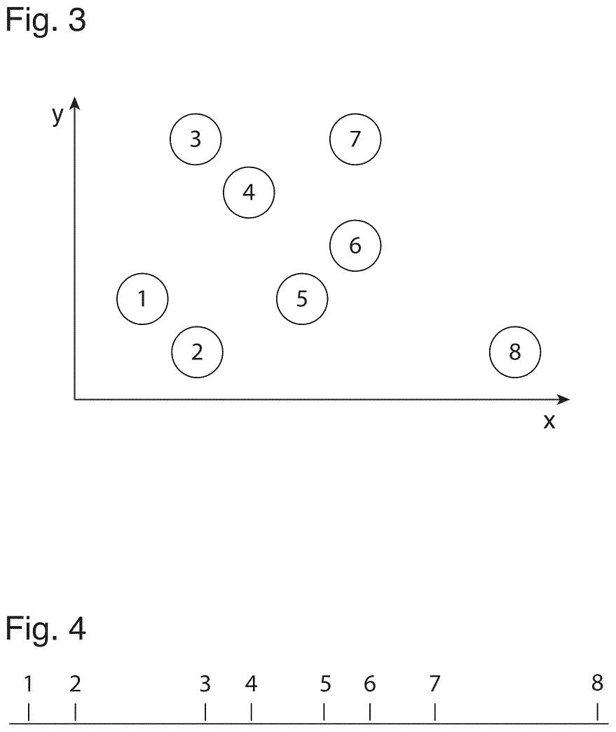

A possible method for forming the sequence will be explained using FIG. 3. There, a two-dimensional point cloud is shown, which consists of only eight points. The sequence is defined by assigning each point an ordinal number between 1 and 8. The points here are primarily ordered by increasing values of the x-coordinate. If two points have the same x-coordinate, they are ordered by increasing values of the y-coordinate. It can be seen that two points that are close to each other in the point cloud are generally also only a short distance apart in the sequence, i.e. their ordinal numbers differ only slightly. For example, the distance between points 1 and 8 is significantly larger than the distance between points 1 and 2.

In FIG. 4, points 1 to 8 are arranged on a straight line such that the distance between two consecutive points on the straight line in the sequence corresponds to the true distance of these points in the x-y plane. Ideally, if the distance in the sequence were identical to the spatial distance in the point cloud, the points in FIG. 4 would have to be arranged on a regular grid. In fact, the grid of points in FIG. 4 is not regular, but it is already relatively close to a regular grid.

Alternatively, the points could of course also be ordered by increasing y-coordinates and, if they match, by increasing x-coordinates. Finally, it would also be possible to combine the two methods by first generating a sequence according to each of the two methods, then arithmetically averaging the ordinal numbers of the point in the two sequences for each point and then ordering a sequence according to increasing values of the obtained average values.

Analogously, one could create a sequence in a three-dimensional point cloud by ordering the points in any order according to the three coordinates. Here, too, different sequences could be combined. Furthermore, it would be possible to project the points of the point cloud onto a plurality of straight lines that are differently oriented in space. In this way, a different sequence of the point cloud would be obtained for each line, and the final sequence could be generated from this again by averaging.

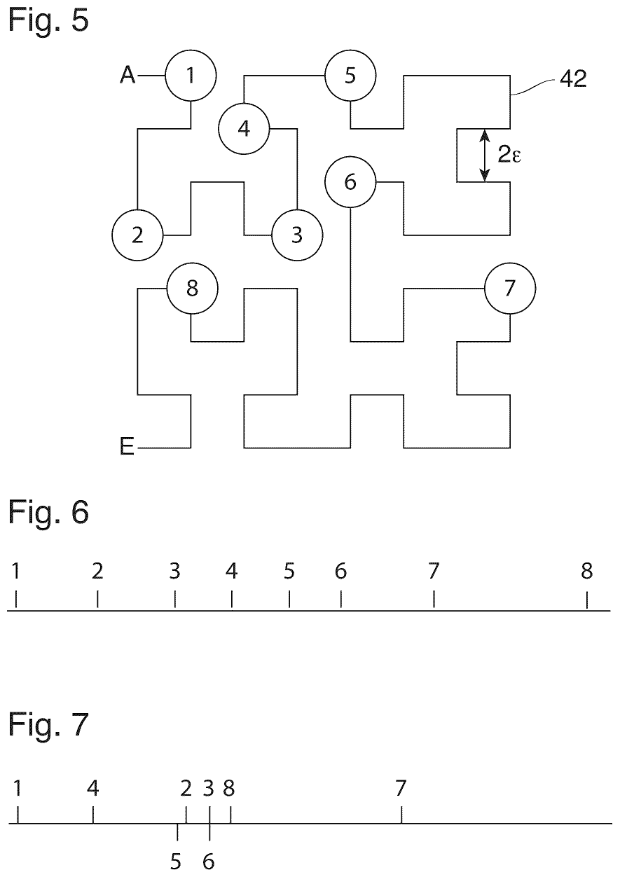

Another method for forming the sequence is shown in FIG. 5. There the same point cloud is shown as in FIG. 3, but a space-filling path 42 is placed under the x-y plane. This path 42 is defined as a continuous mapping from the real numbers into the x-y plane, which has the property that in the considered portion of the plane no point is further away from the nearest point on the path 42 than a specified positive (as small as possible) bounds. In the example shown, the path 42 consists of vertical and horizontal path segments that form a kind of fractal, wherein two adjacent parallel path segments always have the same distance 28 to each other. This ensures that no point of the plane is further than ε from the nearest point of the path 42. The sequence is then formed by following path 42 from the starting point A and the end point E and “collecting” the points of the point cloud along the way and arranging them in the order in which they were collected. It can be seen that here too, at least approximately, two points that are close to each other in the point cloud are also close to each other in the sequence.

In FIG. 6, analogous to FIG. 4, the points 1-8 are arranged on a straight line such that the distances between successive points on the straight line correspond to the true distances in the plane. It can be seen that here too an almost regular grid results.

In FIG. 7, points 1-8 are arranged on a straight line such that the distances of points 2-8 to point 1 correspond to the true distances in the point cloud. Here, too, one can see a certain correlation between the distances in the sequence and the true distances in the plane, but there are some outliers. For example, the true distance between points 1 and 4 is significantly smaller than the distance between points 1 and 2, and the distance between points 1 and 7 is significantly larger than the distance between points 1 and 8. Nevertheless, even with this sequencing method the neighborhood relationships between the points are reproduced approximately correctly.

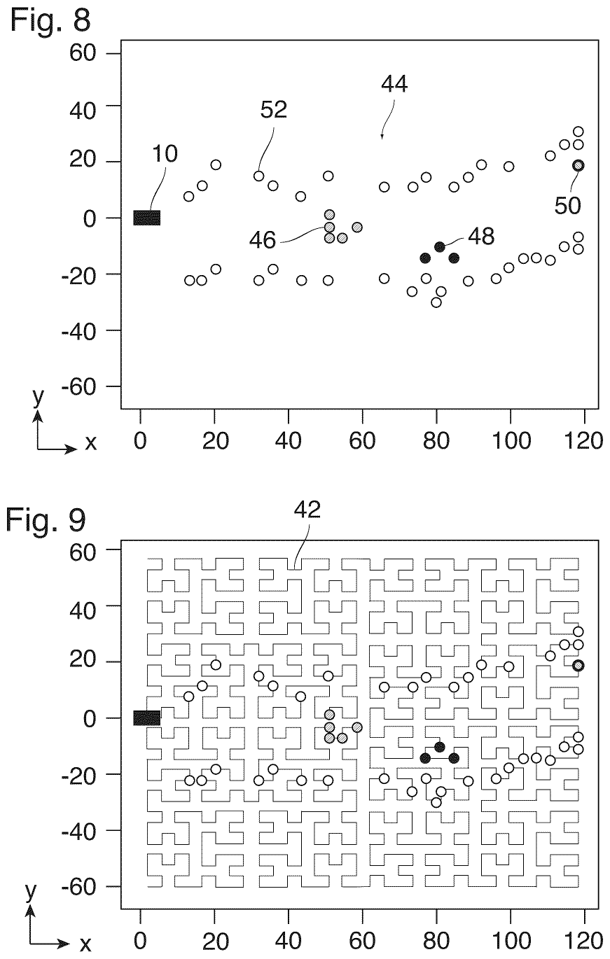

FIG. 8 shows a somewhat more realistic point cloud 44, such as could be recorded by the radar sensor 10 of a motor vehicle. Point cloud 44 contains points 46, 48, 50 and 52, which differ in their area filling. Points with the same area filling correspond to radar targets that have the same radial velocity. The area filling thus represents a feature of the points and makes it possible to identify objects in the point cloud that consist of spatially close radar targets with (approximately) the same radial velocity.

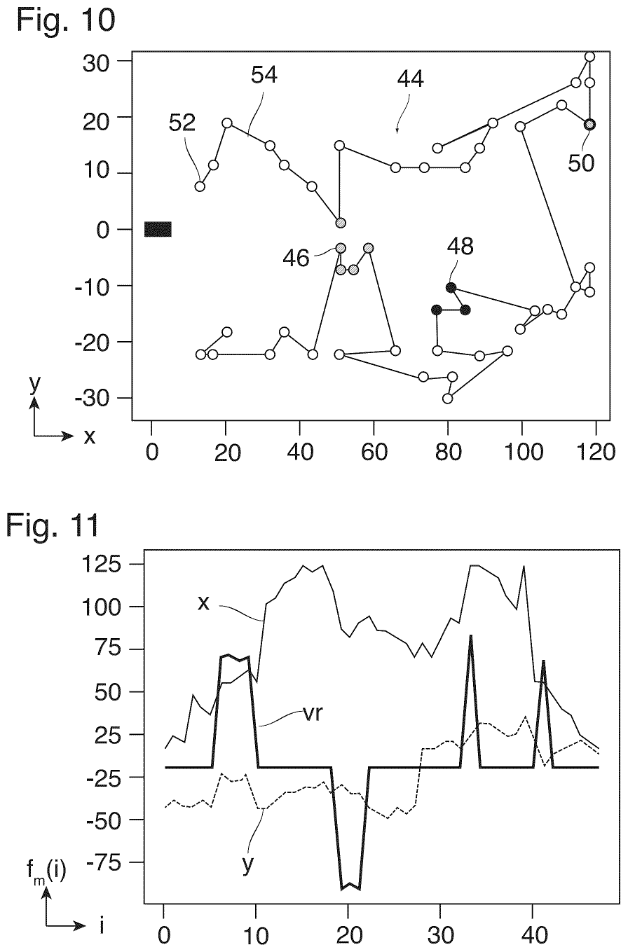

FIG. 9 shows the same point cloud as FIG. 8, but here the x-y plane is underlaid with the area-filling path 44, which allows the points to be arranged into a sequence. FIG. 10 shows a neighborhood graph for the sequence formed according to FIG. 9. Points 46-52 are shown in their true position in point cloud 44, but points that are adjacent to each other in the sequence are connected by an edge 54. The process is similar to a drawing guide for children, where prominent points of a drawing are pre-printed and the child is instructed to connect the points in a specific order using straight lines (“connect the dots”). The procedure will therefore be referred to as the CTD procedure in the following. It can be seen that here too the neighborhood relationships in the sequence correlate well with the true neighborhood relationships. For example, the three points 48 that are close to each other in the point cloud are also connected by edges in the graph. However, for points 46 this correlation is not complete. Here, only four points are connected by edges, while the fifth point is not connected to the remaining four points, so that the object represented by these 46 points is, so to speak, “torn apart.” This error can and must be corrected in later processing steps.

FIG. 11 shows the graphs of three functions fₘ(i), which indicate the values of the features x-coordinate, y-coordinate and radial velocity as a function of the ordinal number i (i.e. the position of the point in the sequence) for the sequence given by the neighborhood graph in FIG. 10. The curve labeled x indicates the x-coordinate, the curve labeled y indicates the y-coordinate and the bold curve vr indicates the radial velocity. The fact that the neighborhood relationships in the point cloud correlate well with the neighborhood relationships in the sequence is reflected here in the fact that the curves for x and y are relatively “smooth” and do not jump erratically between very large and very small values. The curve for the radial velocity vr has clearly negative values only for ordinal numbers close to i=20, which indicate the points 48 in the neighborhood graph (FIG. 10). These points 48 therefore represent an object approaching the home vehicle. Furthermore, the radial velocity curve has three positive peaks. One of them is located at i=33 and represents an object moving away, corresponding to point 50 in the point cloud. The other two positive deflections at i<10 and i=42 belong to the “torn apart” object represented by points 46.

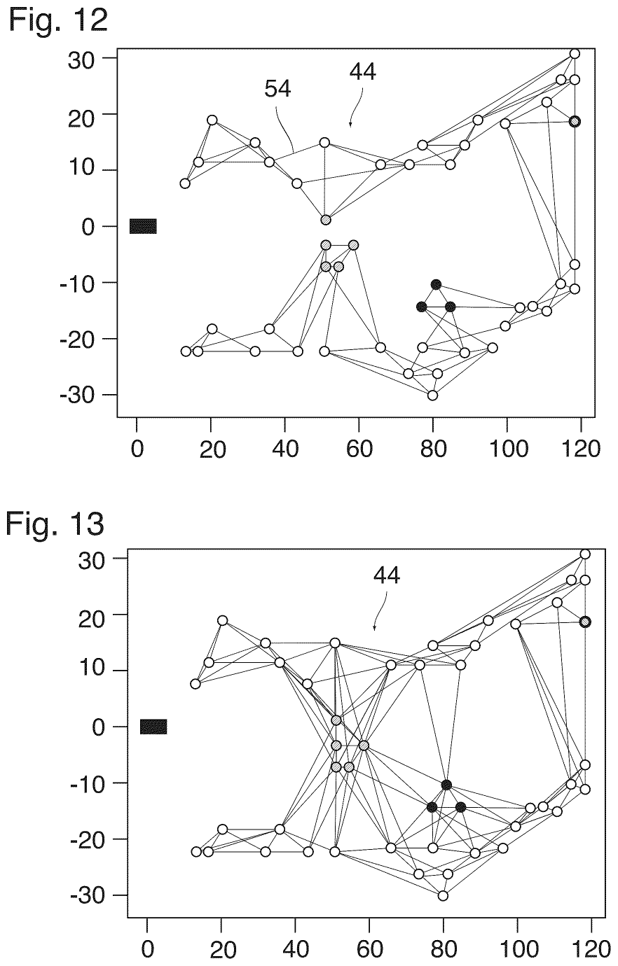

FIG. 12 shows a neighborhood graph in which each point of the point cloud 44 (except the points at the beginning and end of the sequence) is connected to its four nearest neighbors by four edges 54. This corresponds to the neighborhood 20 in FIG. 1 with j=2.

For comparison, FIG. 13 shows a neighborhood graph for the point cloud 44, which was created independently of the sequence based on the real neighborhood relationships. Each point is connected to the neighboring points whose distance is below a certain threshold. It can be seen that the neighborhood graph in FIG. 12 formed using the sequence is a good approximation for the “real” neighborhood graph in FIG. 13.

By padding at the beginning and end of the sequence, it can be ensured that the points at the beginning and end of the sequence also have the full number of (partially virtual) neighbors, so that the convolution operation has the same mathematical form for all points.

If the point cloud has been ordered into a sequence using one of the methods described above, the convolution operation can be performed using a neural network in which each unit of the input layer is assigned to exactly one point in the sequence and each unit of the subsequent (convolutional) layer is also assigned to exactly one point in the sequence.

If the point cloud has dimension D (typically 2 or 3) and each point of the point cloud has C features (in the narrow sense), then a single point xᵢ of the point cloud can be completely described by a vector fᵢ with D+C components. The convolution operation, hereinafter referred to as CTD operation, then consists of the following operation:

$${CTD}_{w} ( {x}_{i} ) = {\sum }_{k = - {j}^{k = j}} {w}_{k} {f}_{( i + k )} + b$$

Since CTD_{w}(xᵢ) is the result of the convolution operation for a single output channel of the unit belonging to the point xᵢ, wₖ is a row vector forming the k-th row of a weight matrix W, f₍ᵢ₊ₖ₎ is the vector that specifies the expanded features of the point with ordinal number i+k, and b is the bias mentioned above. The index k runs from −j to +j. Summation is therefore done over the feature vectors of the 2j+1 points that form the neighborhood of the point xᵢ, each weighted with learned weight factors that form the components Wₖ₁ of the row vector wₖ. These components Wₖ₁ define the kernel of the convolution operation (for one output channel).

This CTD operation is invariant under position shifts in the sequence of points. This means that if the weight matrix has been trained to detect a particular structure in the point cloud, it will detect this structure regardless of where the structure is located in the sequence.

However, the CTD operation is not necessarily translation-invariant with respect to the spatial position of the points in the point cloud. However, this problem can be alleviated by imposing certain restrictions on the weight matrix Wₖ₁. It is advisable to require that the components W_{kd} of the weight matrix forming column d add to zero if d is the index of a component of the vector f specifying a spatial coordinate. For example, if the vector f has the components (x, y, vr), one would require:

$${\sum }_{k} {W}_{k 1} = 0 and {\sum }_{k} {W}_{k 2} = 0.$$

If a spatial translation is then performed, for example in the x-direction, by replacing the x-coordinate for all points with x+Δx, it can be calculated that during the CTD operation the terms dependent on Δx add to zero and thus do not change the result.

As a simple example, we will consider a semantic segmentation that classifies each point of the point cloud into one of the following four classes:
Vehicles
Vulnerable objects (pedestrians, bicyclists, motorcyclists)
Static objects
Padding

Furthermore, it is assumed that the point cloud contains N=256 points and that each point has two features in the narrower sense (vr and the radar cross section), including the two location coordinates, i.e. four expanded features.

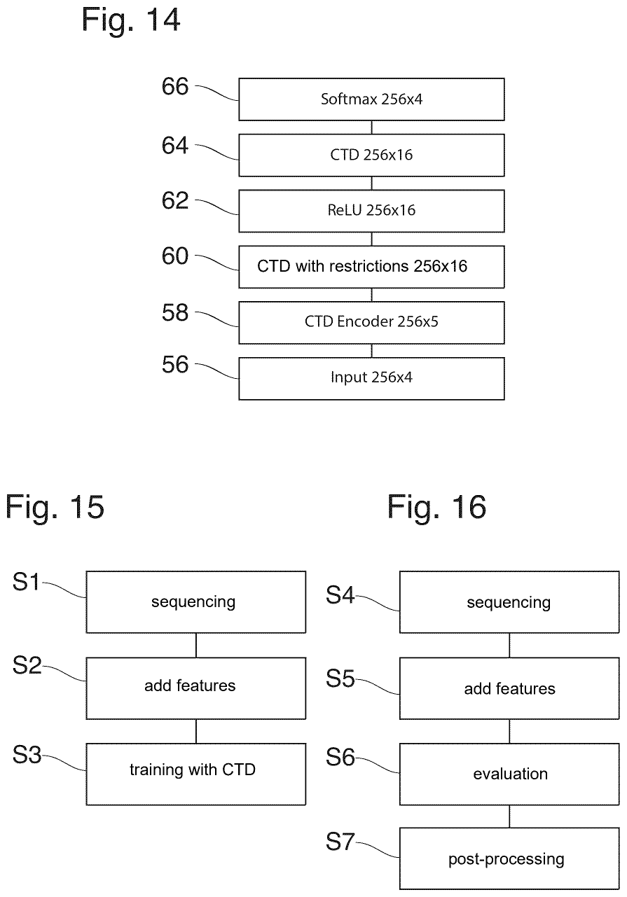

A possible architecture of the network is shown in FIG. 14.

Input data 56 are formed by 256×4 variables. An encoder 58 sorts the points represented by the input data first by increasing x-coordinates and secondarily by increasing y-coordinates, performs padding at the ends of the sequence and combines the coordinates and features into an extended feature vector (including the information about virtual points). A CTD layer 60 performs the convolution operation for a neighborhood of 25 points (j=12), with a weight matrix constrained so that translation invariance is achieved. Each unit of this CTD layer has 16 output channels, so the result consists of 256×16 variables. A non-linear activation function 62 (ReLu; Rectified Linear Unit) is applied to this result. In a second CTD layer 64, a CTD operation with the same neighborhood and the same number of output channels as in the first layer 60 is again applied to the results of the activation function. Finally, the well-known softmax activation function (a smoothed maximum function applied to each of the 16 output channels of layer 64) provides four output variables that indicate, for each of the four classes mentioned above, the probability that the point belongs to that class.

FIG. 15 shows a flow diagram of the essential steps of a training procedure for the network according to FIG. 14. In a first step S1, the points of the point cloud are arranged into a sequence according to one of the above-described methods. In an optional step S2, further features may be added if necessary, for example an index that characterizes the space-filling path 42 in more detail. Finally, in step S3, the network is trained in the usual way by applying a CTD operation with an arbitrarily chosen weight matrix to the training data, comparing the results with the correct classification of the points to calculate a loss function, which is then minimized by adjusting the weights in the weight matrix, for example, by back-propagation, after which the process is repeated with further training data. Restrictions can be imposed on the weight matrix to ensure at least approximate translation invariance.

FIG. 16 is a flow diagram showing how the network works during the actual semantic segmentation. The first two steps S4 and S5 correspond to steps S1 and S2 in the training run according to FIG. 15. In step S6 the actual segmentation and an evaluation of the network takes place. In step S7, if necessary, post-processing is carried out to eliminate errors, for example NMS (non-maximum suppression).

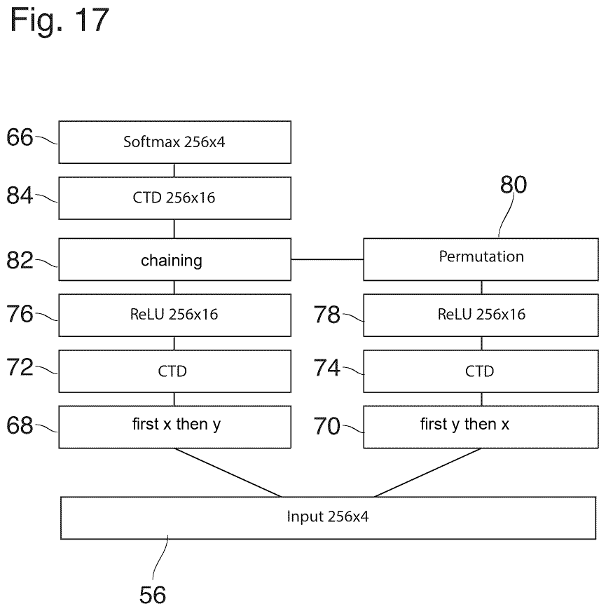

FIG. 17 shows an alternative architecture of the neural network in which two different sequencing methods are combined. The input data 56 are sorted in a first sequencer 68, primarily according to increasing x-coordinate and secondarily according to increasing y-coordinate. In parallel, they are sorted in a second sequencer 70, primarily according to increasing y-coordinate and secondarily according to increasing x-coordinate. The sequencers are followed by a CTD layer 72 or 74 and then an activation level 76 or 78. The activation stage 78 is followed by a permutation stage in which the points in the sequence are rearranged so that the sequence of points corresponds to the sequence generated in the sequencer 68. The results of the activation stage 76 and permutation stage 80 are concatenated in a concatenation stage 82, so that instead of 16 output variables, 32 output variables are obtained per point. The concatenation stage is followed by a second CTD layer 84, in which the number of output variables is reduced again to 16, followed by the same softmax activation 66 as in FIG. 14. The different sequencing allows the method to be better adapted to different point cloud geometries. In general, it is advisable to first sort according to the location coordinate in which the point cloud has the largest extent.

According to a further variant, a network can also be used which has more than two branches in which the points are sequenced in different ways, for example using polar coordinates with primary sorting by increasing azimuth angles and secondary sorting by distance or vice versa. It is also possible to permute the points before they are passed to the second CTD layer.

What is claimed is:

1. A method for semantic segmentation of a point cloud by a neural network in a driver assistance system for motor vehicles, the method comprising the following steps:
defining a neighborhood for each point of the point cloud, the neighborhood being a set of other points of the point cloud located in a vicinity of the point;
convolving a feature of a point of the point cloud is convolved with features of the points in the neighborhood of the point according to a learned weight matrix; and
ordering the points of the point cloud to form a sequence by assigning each point an ordinal number which indicates position of the point in the sequence, wherein an algorithm is used to create the sequence, the algorithm ensuring that a difference between the ordinal numbers of any two points correlates positively with a spatial distance of the two points in the point cloud, and that the neighborhood of a point is defined as a set of points of which the ordinal numbers form a series of consecutive numbers containing the ordinal number of the point.

2. The method according to claim 1, wherein location coordinates of the points are treated as generalized features of the points.

3. The method according to claim 1, wherein the sequence is created by sorting the points according to at least one location coordinate.

4. The method according to claim 3, wherein the points are sorted primarily according to a first location coordinate and secondarily according to a second location coordinate, wherein the order of sorting is selected depending on a geometry of the point cloud.

5. The method according to claim 1, wherein the sequence is created by filling a space occupied by the point cloud with a space-filling path and sorting the points in an order in which the points are encountered along the space-filling path.

6. The method according to claim 1, wherein a plurality of sequencing methods are combined to create the sequence.

7. The method according to claim 1, wherein a plurality of sequences are created using different sequencing methods, the sequences are then further processed in parallel, and results of the processing are fused.

8. The method according to claim 1, wherein a substantial translation invariance with respect to translations of the points of the point cloud in space is produced by specifying restrictive conditions for components of the weight matrix.

9. The method according to claim 1, wherein results of the convoluting are subjected to a further convolution operation with the same neighborhood.

10. A driver assistance system for motor vehicles, comprising:
a data processing system configured for semantic segmentation of a point cloud by a neural network in a driver assistance system for motor vehicles, the data processing system configured to perform the following steps:
defining a neighborhood for each point of the point cloud, the neighborhood being a set of other points of the point cloud located in a vicinity of the point,
convolving a feature of a point of the point cloud is convolved with features of the points in the neighborhood of the point according to a learned weight matrix, and
ordering the points of the point cloud to form a sequence by assigning each point an ordinal number which indicates position of the point in the sequence, wherein an algorithm is used to create the sequence, the algorithm ensuring that a difference between the ordinal numbers of any two points correlates positively with a spatial distance of the two points in the point cloud, and that the neighborhood of a point is defined as a set of points of which the ordinal numbers form a series of consecutive numbers containing the ordinal number of the point.
